(19) United States
(12) Patent Application Publication
(10) Pub. No.: US 2006/0083824 A1
(43) Pub. Date: Apr. 20, 2006

(54) Nutritional supplements for glucose intolerant individuals

(75) Inventors: Paul B. Manning, Keswick, VA (US); Cynthia M. Barber, Gordonsville, VA (US); Raymond J. Maggio, Collegeville, PA (US)

Correspondence Address: NIXON & VANDERHYE, PC, 901 NORTH GLEBE ROAD, 11TH FLOOR, ARLINGTON, VA, 22203, US

(73) Assignee: PBM PRODUCTS LLC, Gordonsville, VA (US)

(21) Appl. No.: 11/159,387

(22) Filed: Jun. 23, 2005

Related U.S. Application Data
(63) Continuation-in-part of application No. 10/973,210, filed on Oct. 25, 2004.
(60) Provisional application No. 60/620,819, filed on Oct. 20, 2004.

(51) Int. Cl. A23L 1/30

(52) U.S. Cl. 426/72

(57) ABSTRACT

Nutritional supplements which are especially useful for consumption (either orally or enterally) by glucose intolerant individuals. More specifically, sugar-free nutritional supplement formulations for glucose intolerant patients include docosahexaenoic acid (DHA), L-arginine, one or more edible fats and/or oils in an amount sufficient to provide between about 25 to about 60% of the total caloric value of the formulation, non-sugar carbohydrates in an amount sufficient to provide from about 2% to about 30% of the patient's daily energy requirements, proteins and/or amino acids in an amount sufficient to provide from about 5% to about 50% of the human's daily energy requirements, an artificial sweetener in an amount to impart a desired sweetness to the formulation, and a mineral and vitamin package containing minerals and vitamins in amounts sufficient to provide at least 10% of the recommended daily value (RDV) of each mineral and vitamin in the package. The formulations may be provided as liquids or as a solid bar for patient consumption.

### CROSS-REFERENCE TO RELATED APPLICATION

This application is a continuation-in-part (CIP) of copending U.S. patent application Ser. No. 10/973,210 filed on Oct. 25, 2004, which in turn is based on, and claims domestic priority benefits under 35 USC §119(e) from, U.S. Provisional Patent Application Ser. No. 60/620,819 filed on Oct. 20, 2004, the entire content of each prior-filed application being expressly incorporated hereinto by reference.

### FIELD OF THE INVENTION

The present invention relates to nutritional supplements, such as nutritional ready-to-drink beverages, liquid concentrates, solid concentrates and food bars, for an administration to humans by oral consumption or enterally. In especially preferred embodiments, the present invention relates to nutritional supplements which are especially formulated to meet the specific needs of glucose intolerant individuals.

### BACKGROUND AND SUMMARY OF THE INVENTION

Several distinct disorders of glucose tolerance (glycemia) presently exist, such as diabetes mellitus (types 1 and 2), other specific types of diabetes, gestational diabetes mellitus (GDM), impaired glucose tolerance (IGT) and impaired fasting glucose (IFG). Diabetes mellitus (“diabetes”) is a medical disorder that is characterized by varying or persistent hyperglycemia (elevated blood sugar levels), especially after eating. Thus diabetic individuals typically must adhere to a strict diet which minimizes postprandial glucose response. In some cases, diabetic individuals must also employ suitable medications, such as insulin and/or oral hypoglycemic agents.

Several nutritional formulations for providing glucose intolerant individuals are known as exemplified by U.S. Pat. No. 4,921,877 to Cashmere et al and U.S. Pat. No. 6,774,111 to Wolf et al (the entire content of each patent being incorporated expressly by reference herein). According to Cashmere et al '877, a nutritionally complete formula is proposed having protein, a carbohydrate blend comprised of corn starch, fructose and soy polysaccharide, a fat blend, protein, and effective amounts of vitamins and minerals. Wolfe et al '111 provides a nutritional supplement comprised of protein, fat, and a carbohydrate system containing fructose, digestible glucose polymers, nonabsorbent carbohydrates, fiber and indigestible oligosaccharides.

While such prior nutritional formulations may be satisfactory for administration to glucose intolerant individuals, they each contain fructose as an essential ingredient. Fructose is, however, well known to increase plasma lipid levels and therefore is contraindicated for use by glucose intolerant (e.g., diabetic) individuals.

Therefore, what has been needed are sugar-free, especially fructose-free, nutritional supplement formulations for glucose intolerant individuals which minimize (if not eliminate entirely) the risks to the individual of an increased lipid level response. Moreover, it would be especially desirable if such sugar-free nutritional supplements could be formulated to address other diabetes-related complications, for example, to decrease the risk of cardiovascular disease—that is, be “heart-healthy”. It is towards fulfilling such needs that the present invention is directed.

Broadly, the present invention is embodied in sugar-free nutritional supplements which are especially useful for consumption (either orally or enterally) by glucose intolerant individuals. More specifically, according to a particularly preferred aspect of the present invention, sugar-free nutritional supplement formulations for glucose intolerant patients consisting essentially of docosahexaenoic acid (DHA), L-arginine, one or more edible fats and/or oils in an amount sufficient to provide between about 25 to about 60% of the total caloric value of the formulation, non-sugar carbohydrates in an amount sufficient to provide from about 2% to about 30% of the human's daily energy requirements, proteins and/or amino acids in an amount sufficient to provide from about 5% to about 50% of the human's daily energy requirements, an artificial sweetener in an amount to impart a desired sweetness to the formulation, and a mineral and vitamin package containing minerals and vitamins in amounts sufficient to provide at least 10% of the recommended daily value (RDV) of each mineral and vitamin in the package.

Preferably, the nutritional supplement formulations will contain DHA in an amount between about 0.01 to about 1.25 wt. % based on total formulation weight and/or L-arginine in an amount between about 0.10 to about 5.0 wt. % based on the total formulation weight.

Advantageously, the nutritional supplement formulations will contain at least one additional fatty acid other than DHA which is selected from the group consisting of omega-3, omega-6 and omega-9 fatty acids. In one aspect of the invention, such additional fatty acid is most preferably present in an amount less than about 0.10 wt. % based on total formulation weight.

According to one embodiment, the nutritional supplement will include edible fats and/or oils derived from a fat blend which includes saturated fat in an amount from about 5 to about 14 weight percent based total fat blend weight, monounsaturated fat in an amount from about 30 to about 80 weight percent based on total fat blend weight, and polyunsaturated in an amount from about 10 to about 40 weight percent based on total fat blend weight.

The nutritional supplement formulation may contain carbohydrates derived from a carbohydrate blend which includes maltodextrin in an amount from about 40 to about 95 wt. % based on total carbohydrate blend weight, inulin in an amount from about 2.0 to about 15.0 wt. % based on the total carbohydrate blend weight, cellulose gel in an amount from about 1.0 to about 15 wt. % based on total carbohydrate blend weight, and gum arabic in an amount from about 0.25 to about 6.0 wt. % based on total carbohydrate blend weight.

The proteins and/or amino acids that are preferably included in the nutritional formulations of this invention include at least one protein selected from the group consisting of cereal proteins, milk proteins, egg proteins, whey proteins, bean proteins, soy proteins and peanut proteins. Most preferably, at least one milk protein is present and is selected from calcium caseinate, sodium caseinate, sodium calcium caseinate, lactalbumin-casein coprecipitate, and casein.

The ingredients of the nutritional formulations may be homogenously mixed together and formulated with water to provide a concentrated liquid or a ready-to-drink liquid. Alternatively, minimal water may be present and the nutritional formulations may be formed into a solid food bar. The nutritional formulations may thus be administered orally or enterally in nutritionally supplemental sufficient amounts to glucose-intolerant patients in need of nutritional supplement.

These and other aspects and advantages will become more apparent after careful consideration is given to the following detailed description of the preferred exemplary embodiments thereof.

### DETAILED DESCRIPTION OF THE INVENTION

The nutritional supplements of the invention can be employed as a dietary intervention adjunct to professional medical treatment for borderline diabetes, diabetes, other glucose intolerance disorders, cardiovascular disease and other illnesses, the treatment course of which may include a recommendation or need for a fructose-free food product.

The nutritional supplements of the invention comprise a nutritionally balanced formulation of edible fats and/or oils, carbohydrates and protein that minimizes the risk of chronic diseases that are more commonly found in diabetics and other glucose intolerant humans, as well as certain nutrients that are associated with increasing insulin sensitivity. More particularly, the nutritional supplements of this invention will comprise a fructose-free homogenous blend of edible fats and/or oils, carbohydrates and protein and a heart-healthy combination of omega-3 fatty acids and essential amino acids, specifically DHA (docosahexaenoic acid) and L-arginine.

In general, the nutritional supplement formulations of the present invention may be prepared by any technique well known to those skilled in the food preparation art. For example, when preparing a liquid formulation, a fat blend may be prepared containing all oil ingredients, an emulsifier, and the fat-soluble vitamins. The fat blend is the compounded (mixed) with water and other ingredients, except for the water-soluble vitamins. The mixture is mixed while heated, filtered and homogenized. After cooling, the water-soluble vitamins are added.

The liquid may be concentrated and packaged for sale as a concentrate whereby the end user adds additional potable liquid (e.g., additional water, milk, fruit juice and the like) so as to create a drinkable liquid. Alternatively, the formulation may contain sufficient potable liquid and packaged as a ready-to-drink formulation. Solid food bars may be prepared generally in accordance with U.S. Pat. Nos. 6,569,445 and 6,576,253 (the entire content of each being expressly incorporated hereinto by reference) using the ingredients in accordance with the present invention. A powdered formulation may also be provided whereby substantially all liquid is evaporated therefrom. The powdered formulation may thus be used as is in a mixture with other edible foods and/or converted to a drinkable liquid by addition of sufficient amounts of a potable liquid.

The various ingredients that may be included in the formulations of the present invention will be discussed in greater detail below.

1. Fatty Acids

The formulations of the present invention will necessarily include the omega-3 fatty acid, DHA, for the purpose of imparting a strong anti-inflammatory and cardio protective benefit.

The DHA that may be employed satisfactorily in the practice of the present invention may be obtained from any source, including aquatic animals, for example, fish oil. For safety reasons, however, it is preferable that the source of the DHA (and any other omega-3 fatty acids), such as fish oil, and the DHA (and any other omega-3 fatty acids), do not contain a detectable hazardous level of mercury, a detectable hazardous level of any heavy metals, a detectable hazardous level of any pesticides or a detectable hazardous level of any industrial chemicals, as measured using conventional detection techniques (such as those described herein). It is also preferable that the source of DHA (and any other omega-3 fatty acids), such as fish oil, contains at least about 30 weight percent of DHA (or of another omega-3 fatty acid). Such DHA (and other omega-3 fatty acids) can be produced by those of skill in the art using conventional oil or omega-3 fatty acid refinement processes and equipment.

For the same reasons, it is more preferable that any DHA (or other omega-3 fatty acids) that is employed in the nutritional supplements be a high grade DHA (or other omega-3 fatty acid) that is obtained from a source that is not an aquatic animal, for example, DHA (or another omega-3 fatty acid) that is obtained from a plant or fungal source, such as algae, microalgae or other seaweed. Such DHA and other omega-3 fatty acids are generally safe for developing fetuses of pregnant women, as well as for breast-fed babies of lactating women (and for other humans). Most preferably, DHA is obtained from microalgae. One particularly preferred commercial source of DHA is Martek Corp. (Columbia, Md.).

Most preferably, DHA will be present in the formulations of the present invention in an amount between about 0.01 wt. % to about 1.25 wt. %, and more preferably between about 0.02 wt. % to about 0.50 wt. %, based on the total formulation weight. In especially preferred embodiments of the invention, DHA will be present in ready-to-drink liquid formulations in an amount between about 0.04 wt. % to about 0.06 wt. %.

DHA may be employed singly or in combination with one or more other fatty acids, such as one or more other omega-3, omega-6 and/or omega-9 fatty acids. More specifically, fatty acids may be employed which are selected from the group consisting of butyric acid, caproic acid, caprylic acid, capric acid lauric acid, myristic acid, palmitic acid, palmitoleic acid, stearic acid, oleic acid, linoleic acid, alpha-linolenic acid, gamma-linolenic acid, arachidic acid, gadoleic acid, arachidonic acid, eicosapentaenoic acid, behenic acid, erucic acid, and lignoceric acid. If used, such other fatty acids will be present in amount less than 0.10 wt. %, and usually between about 0.001 to about 0.08 wt. %, based on the total formulation weight.

2. L-Arginine

The formulations will necessarily include the essential amino acid, L-arginine. Most preferably, L-arginine will be present in amounts between about 0.10 wt. % to about 5.0 wt. %, more preferably between about 0.25 wt. % to about 2.5 wt. %, based on the total formulation weight. In especially preferred embodiments, L-arginine will be present in ready-to-drink liquid formulations of the invention in an amount between about 0.35 wt. % to about 0.50 wt. %.

3. Edible Fats and/or Oils

The formulations of the present invention will also necessarily contain one or more edible fats and/or oils in an amount sufficient to provide between about 25 to about 60% of the total caloric value of the formulation, preferably between about 30 to about 45% of the total caloric value. In especially preferred embodiments, the edible fats and/or oils are present in an amount sufficient to provide about 40% (+/− about 0.5%) of the total caloric value of the formulation.

Preferably, the one or more edible fats and/or oils that are included in the nutritional supplements of the invention contain one or more beneficial nutrients, such as omega-3 fatty acids (other than DHA), omega-6 fatty acids, omega-9 fatty acids and/or essential fatty acids. Polyunsaturated fats and/or oils generally have anti-inflammatory effects and improve circulation in diabetic, borderline diabetic and geriatric humans, as well as in humans that have, are at risk for, or develop other glucose intolerance or cardiovascular disease, and in other humans.

The total amounts of edible fats and/or oils that are present in the nutritional supplements of the invention are present in amounts that provide from about 1% to about 50% of a human's daily energy requirements, more preferably from about 3% to about 35%, and most preferably between about 5% to about 15% of such daily energy requirements. The amounts included in the formulations may vary widely depending upon the numbers, and types, of fats and/or oils that are employed in the nutritional supplements, and like considerations, and may readily be determined by those of skill in the art. Such an amount should be sufficient to help support the human body's nutritional needs for fat, while minimizing a risk for chronic disease.

In general, the amounts of edible fats and/or oils present in the formulations in accordance with the present invention will range from between about 1.0 wt. % to about 30 wt. %, more preferably between about 2.0 wt. % to about 15 wt. %, based on the total formulation weight. In especially preferred embodiments, the amount of edible fats and/or oils present will be present in the ready-to-drink liquid formulations in an amount ranging between about 2.0 wt. % to about 5.0 wt. %, based on total formulation weight.

The nutritional supplements of the invention preferably contain an amount of trans fat that provides about 10% or less of daily energy requirements, an amount of saturated fat that provides about 10% or less of daily energy requirements (and more preferably about 7% or less), an amount of monounsaturated fats that provides from about 1% to about 20% of daily energy requirements, and an amount of polyunsaturated fats that provides from about 1% to about 10% of daily energy requirements.

The nutritional supplements of the invention preferably employ a unique monounsaturated dominant fat blend of high oleic sunflower or safflower oil and high oleic canola oil, along with soy lecithin and the very long chain polyunsaturated fatty acid, DHA. This fat blend preferably has zero trans fatty acids, zero cholesterol, very low saturated fat (about 3% of DV).

Nutritional supplements within the scope of the present invention may or may not include detectable levels of soy oil or high oleic safflower oil (as measured using conventional detection processes and equipment).

Any one or more of a wide variety of edible fats and/or oils may be employed satisfactorily in the nutritional supplements of the present invention. Because of their nutrient and/or medical benefits, edible fats and oils that are preferred for use in the nutritional supplements of the invention are those that are, or are rich in (contain large quantities o n, essential fatty acids, omega-3 fatty acids, omega-6 fatty acids and/or omega-9 fatty acids, particularly, arachidonic acid, alpha-linolenic acid and/or gama-linolenic acid. The edible fats and oils that may be employed in the nutritional supplements of the invention are commercially available from a number sources well known by those of skill in the art.

Edible fats and oils, such as omega-3 oils, are generally commercially available in the ethyl esters, triglycerides or free fatty acids forms. The ethyl esters form of edible fats and oils result from the ethylation of the original triglyceride molecules to thereby increase or concentrate the level of omega-3 fatty acids, while removing the less desirable fatty acids. One preferred ethyl ester of DHA are available from DSM (Heerlen, NL) under the name Ropufa® 75 n-3 EE.

The triglycerides form of edible fats and oils generally consists either of an unconcentrated oil, or of a concentrated oil that has been reconverted (re-esterified) back to the tri-glycerides form. In the processing of edible oils, the objective is generally to remove existing free fatty acids, monoglycerides and diglycerides to form more stable compositions of the fatty acids, which is the triglycerides or ethyl esters forms of the fatty acids.

The fatty acids form of edible fats and oils generally results from saponification and neutralization of the triglycerides, using known techniques, whereby the glycerol backbone of the triglycerides is generally severed, leaving only the free fatty acid form. Such processing techniques preferably result in the edible fats and oils having an acid value below about 3.0 mg KOH/g and unsaponified matter below about 1.5% w/w.

Oils extracted from seeds, plants and fruits and other sources may be employed satisfactorily in the present invention. Such oils may be used in their virgin, or unrefined state, or may be refined provided that refinement does not result in significant loss of nutrients.

In order to permit edible fats and/or oils employed in the nutritional supplements of the invention to provide maximum health benefits, it is also preferred that the edible fats and oils be non-hydrogenated.

A preferred fat blend for use in the nutritional supplements of the invention includes:
(a) saturated fat, from any source, in an amount generally ranging from about 5 to about 14 weight percent of the total fat blend, and preferably ranging from about 5 to about 10 weight percent, with about 9 weight percent being most preferred;
(b) monounsaturated fat, from any source, in an amount generally ranging from about 30 to about 80 weight percent of the total fat blend, and preferably ranging from about 50 to about 70 weight percent, with about 69 weight percent being most preferred; and
(c) polyunsaturated fat, from any source, in an amount generally ranging from about 10 to about 40 weight percent of the total fat blend, and preferably ranging from about 15 to about 25 weight percent, with about 22 weight percent being most preferred.

Diacylglycerols are naturally occurring compounds found in many edible oils. Through interesterification, an edible oil containing increased level of diacylglycerols has been produced that shows different metabolic effects compared to conventional edible oils. Differences in metabolic pathways between 1,3 diacylglycerol and either 1,2 diacylglycerol or triglycerides allow a greater portion of fatty acids from 1,3 diacylglycerol to be burned as energy rather than being stored as fat. Clinical studies have shown that regular consumption of diacylglycerol oil as part of a sensible diet can help individuals to manage their body weight and body fat. Advantageously, therefore, the fat blend may include diacylglycerol oil in an amount sufficient to provide up to about 10% of the human's daily energy requirements from fat. If present, the diacylglycerol oil may be included in the fat blend in amount up to about 80 weight percent (based on the total fat blend weight).

As a result of the nutritional, medical and/or other benefits that they can provide to humans, the preferred edible fats and oils for use in the nutritional supplements of the invention include omega-3 fatty acids, omega-6 fatty acids and omega-9 fatty acids, such as alpha-linolenic acid, docosapentaenoic acid, moroctic acid, heneicosapentenoic acid, gamma-linolenic acid, linoleic acid, arachidonic acid and oleic acid. As a result of an enhanced stability, such such fatty acids are preferably present in their ethyl esters or tryglycerides forms.

In order to obtain a good edible fat or oil distribution within a mixture of ingredients used to form nutritional supplements within the scope of the present invention, edible fats that are solid at room temperature may be heated to a temperature ranging from about 100° F. to about 220° F., and preferably to a temperature ranging from about 160° F. to about 172° F. If a solid fat is not heated sufficiently, it will not melt and, thus, will not mix easily with the other ingredients. However, in order to minimize off-flavors that may result from heating solid fats too long, or at too high of a temperature, or the degrading of vitamins or other ingredients that are mixed with the fats, solid fats should generally only be heated for a period of time, and at a temperature, that is sufficient to transform the solid fats into a liquid or semi-liquid state, and to allow the fats to properly blend with other ingredients.

A wide variety of auxiliary edible fats and/or oils may, optionally, be employed to produce nutritional supplements within the invention. Such fats and oils are preferably those that are effective for providing some additional or other nutritional, medical and/or other health benefit to the nutritional supplements, such as increasing the fat content of the nutritional supplements for nutritional purposes, or for otherwise enhancing the nutrition of diabetic, borderline diabetic, geriatric or other humans, including humans that have cardiovascular disease, pregnant women or their developing fetuses, lactating women or their babies, women having childbearing potential that are attempting to become pregnant, or other humans, and that are not harmful to the humans, or to developing fetuses and/or breast-fed babies. These edible fats and/or oils may provide other essential fatty acids that may enhance nutrition, and include, but are not limited to, the edible fats and oils described herein, such as plant oils and plant seed oils (corn oil, soy oil, soybean oil, olive oil, canola oil, cotton seed oil, palm oil, palm kernel oil, coconut oil, sunflower oil, high oleic sunflower oil, safflower oil, high oleic safflower oil, peanut oil, walnut oil, almond oil and the like), lecithin, palmolein oil, mustard seed oil, lard, monoglycerides, diglycerides, butter, margarine, and other animal, vegetable, and marine fats, and milk fats, and the like, which are commercially available from sources known by those of skill in the art, and mixtures thereof. Canola oil, for example, provides alpha-linolenic acid, linoleic acid and oleic acid, and is relatively low in saturated fat. Soybean oil provides an additional source of linoleic acid. Preferred oils for use in this manner are soy oil, high oleic sunflower oil, safflower oil, vegetable oil and/or coconut oil.

If present, the one or more auxiliary fats and oils that may be employed in nutritional supplement formulations of the invention generally ranges from about 2.0 to about 7.0 wt. %, preferably from about 3.0 to about 5.0 wt. %, and most preferably about 4 wt. %, based on the total formulation weight.

4. Carbohydrates

The nutritional supplement formulations of the present invention will necessarily include carbohydrates derived from non-sugar sources. As briefly noted above, the nutritional supplement formulations of the present invention are “sugar-free”. That is, the formulations of the present invention are free carbohydrates derived from sugars, such as glucose, fructose and sucrose, but include sufficient nutritional amounts of carbohydrates derived from non-sugar sources, such carbohydrates derived from vegetables, fruits and/or dairy products.

A wide variety of non-sugar carbohydrates may be employed in the practice of the present invention and are available from a number of commercial sources well known to those skilled in this art. For example, the formulations of the present invention may comprise maltodextrin (especially those having a dextrose equivalent of less than about 20), inulin, cellulose, gum arabic, potassium citrate, sodium citrate, citric acid, and the like.

Carbohydrates derived from non-sugars will be present in the formulations of present invention to provide between about 20 to about 70% of the total caloric value of the formulation, preferably between about 35 to about 50% of the total caloric value. In especially preferred embodiments, the edible fats and/or oils are present in an amount sufficient to provide about 38% (+/− about 0.5%) of the total caloric value of the formulation.

Most preferably, the non-sugar carbohydrates will be present in the nutritional supplements of the invention in amounts that provide from about 2% to about 30% of a human's daily energy requirements, more preferably from about 5% to about 15%, and most preferably between about 8% to about 12% of such daily energy requirements. In preferred embodiments, the non-sugar derived carbohydrates will be present in the formulations of the invention in an amount to provide about 10% of the daily energy requirement.

A preferred carbohydrate blend for use in the nutritional supplement formulations of the present invention includes:
(a) maltodextrin in an amount generally ranging from about 40 to about 95 wt. %, based on the total carbohydrate blend weight, more preferably between about 50 to about 85 wt. %, with between about 80 to about 85 wt. % being most preferred;
(b) inulin in an amount generally ranging from about 2.0 to about 15.0 wt. %, based on the total carbohydrate blend weight, more preferably between about 3.5 to about 8.0 wt. %, with between about 5.0 to about 6.0 wt. % being most preferred;
(c) cellulose gel, in an amount generally ranging from about 1.0 to about 15 wt. % based on the total carbohydrate blend weight, more preferably between about 3.0 to about 10 wt. %, with about about 5.0 wt. % being most preferred; and
(d) gum arabic, in an amount generally ranging from about 0.25 to about 6.0 wt. %, based on the total carbohydrate blend weight, more preferably between about 1.0 to about 5.0 wt. %, with between about 2.5 to about 3.5 wt. % being most preferred.

The non-sugar derived carbohydrates will most preferably be present in the formulations of the present invention in an amount between 1.0 wt. % to about 30 wt. %, more preferably between about 5.0 wt. % to about 15 wt. %, based on the total formulation weight. In especially preferred embodiments, the non-sugar derived carbohydrates will be present in the ready-to-drink liquid formulations in an amount between about 5.0 wt. % to about 8.0 wt. %, for example about 7.0 wt. %, based on total formulation weight.

5. Proteins and Amino Acids

The nutritional supplement formulations of the present invention will also include proteins and other amino acids, in addition to L-arginine. A wide variety of one or more edible animal or vegetable proteins and/or amino acids may be employed satisfactorily in the nutritional supplement formulations of the invention and include, for example, cereal proteins, milk proteins (calcium caseinate, sodium caseinate, sodium calcium caseinate, lactalbumin-casein coprecipitate, purified or refined grades of casein and the like), egg proteins, whey protein, bean proteins, soy proteins (soy protein isolate and the like) and proteins from peanuts, all of which are commercially available from sources known by those of skill in the art.

It is preferred that the one or more proteins and/or amino acids that are present in the nutritional supplements of the invention have an ability to supply the human body with essential amino acids in an easily digested form, such as a combination of milk and vegetable proteins. It is also preferred that nutritional supplements of the invention contain a combination or blend of two or more proteins, which combination includes soy protein isolate, such as soy protein (preferably isolated), sodium caseinate and calcium caseinate.

Proteins will be present in the formulations of present invention to provide between about 5 to about 50% of the total caloric value of the formulation, preferably between about 10 to about 35% of the total caloric value. In especially preferred embodiments, the edible fats and/or oils are present in an amount sufficient to provide about 23% (+/− about 0.5%) of the total caloric value of the formulation.

The one or more proteins and/or amino acids are most preferably present in the nutritional supplements of the invention in amounts effective to provide from about 5% to about 50% of the human's daily energy requirements, more preferably from about 10% to about 35% of the human's daily energy requirements, and most preferably from about 17% to about 20% of the human's daily energy requirements. Such an amount will vary widely depending upon the numbers, and types, of proteins and/or amino acids that are employed in the nutritional supplements, and like considerations, and may readily be determined by those of skill in the art. Such an amount should be sufficient to fulfill the human body's daily nutritional needs for protein, while minimizing a risk for chronic disease.

In general, proteins and/or amino acids other than L-arginine will be present in the nutritional formulations of the invention in amounts ranging from about 1.0 to about 25.0 wt. %, based on the total formulation weight, more preferably between about 2.5 to about 8.0 wt. %. For example, the ready-to-drink liquid formulations of the present invention will most preferably include proteins and/or amino acids in an amount ranging between about 4.0 to about 6.0 wt. %.

6. Vitamin and Mineral Package

Vitamins and minerals may be included as a “package” in the formulations of the present invention so as to impart desired nutritional characteristics thereto. In general, the vitamins and minerals are included in such package so as to provide, based on a 2000 calorie diet, at least about 5%, more preferably at least about 10%, most preferably at least about 25% up to about 100% of their respective individual recommended daily values (RDV). Thus, as a sole source of RDV, the vitamins and minerals will be present in the formulations of the present invention in amounts ranging from about 100 calories to about 2000 calories.

Suitable vitamins that may be employed in the practice of this invention include, for example, Vitamins A, B₁, B₂, B₃, B₆, B₁₂, C, D, E, K, beta-carotene, Biotin, Folic Acid, Pantothenic Acid, Niacin, and Choline. Suitable minerals that may be employed in the practice of this invention include, for example, calcium, magnesium, potassium, sodium, phosphorous, and chloride. Suitable trace minerals that may be employed in the practice of the present invention include, for example, iron, zinc, manganese, copper and iodine. Suitable ultra trace minerals that may be employed in the practice of the present invention include, for example, chromium, molybdenum and selenium. Suitable conditionally essential nutrients that may be employed in the practice of the present invention include, for example, m-inositol, carnitine and taurine.

The minerals may be used in their pure form or as salts thereof. Thus, suitable mineral salts that may be employed in the vitamin and mineral package and include, for example, calcium carbonate, calcium sulfate, calcium oxide, calcium hydroxide, calcium apatite, calcium citrate-malate, bone meal, oyster shell, calcium gluconate, calcium lactate, calcium phosphate, calcium levulinate, magnesium carbonate, magnesium oxide, magnesium hydroxide, magnesium sulfate, ferrous sulfate, ferric chloride, ferrous gluconate, ferrous lactate, ferrous tartrate, ferrous fumarate, ferrous succinate, ferrous glutamate, ferrous citrate, ferrous pyrophosphate, ferrous cholinisocitrate, ferrous carbonate and the like.

7. Other Ingredients

The formulations in accordance with the present invention may include as optional components one or more additional ingredients that are conventionally employed in food products such as water, taste agents, thickeners, antioxidants, processing aids, colorants and the like.

A. Water

The weight balance of the formulations in accordance with the present invention will typically be potable water. The amount of water employed to make the nutritional supplements of the invention will depend, in part, upon the form of the nutritional supplement that is being produced (e.g., a ready-to-drink liquid, a solid food bar or the like), and may vary widely. Generally, the amount of water that is employed for a ready-to-drink liquid formulation of the nutritional supplements is an amount that is effective for raising the total weight of the nutritional supplement to 100 percent, and to provide the nutritional supplement with a desired flowability. This amount generally ranges from about 2 to about 95 wt. % based on total formulation weight, preferably from about 65 to about 90 wt. %, with about 75 to about 80 wt. % being most preferred. In contrast, a nutritional supplement of the invention in the form of a solid food bar will typically have a water content that is about 10 wt. % or less, based on the total formulation weight, more preferably between about ranges from about 2.0 to about 8.0 wt. %. In general, a solid food bar form of the invention having a higher moisture content will be more soft (i.e., chewier) as compared to a food bar having a lower moisture content.

B. Taste Agents

In general, one or more taste agents in the form of flavorings, sweeteners and/or taste-masking agents may optionally be employed in the practice of the present invention so as to impart to the nutritional supplement formulation a desirable taste. More specifically, a wide variety of edible natural or artificial flavoring agents (to produce a wide variety of different flavors of the drinks), sweetening agents and/or taste-masking agents which, alone or in combination, may provide sweetness or one or more of a wide variety of food flavors to the nutritional supplements, and/or may mask (reduce or eliminate) an unpleasant taste that an ingredient of the nutritional supplements, such as an edible fat or oil, may have or otherwise impart to food components or products, may be employed in the formulations of this invention. The nutritional supplements of the invention may have any flavor that is known and/or that may be used in food ingredient or food products, and are preferably naturally and/or artificially flavored in a manner that encourages consumer compliance.

One or more taste-masking agent(s) and/or flavoring agents that may, optionally, be chosen for use in the nutritional supplements of the invention may be flavored as, taste and/or smell like cocoa, chocolate, chocolate fudge, peanut butter, butter pecan, vanilla, French vanilla, mocha, coffee, maple, caramel, coconut, brown sugar, white sugar, honey, molasses, corn syrup, marshmallow, citrus oils (lemon oil, oil of orange juice, etc.), various fruit flavors (lemon, lime, orange, grape, pineapple, grapefruit, banana, cherry, raspberry, strawberry, pineapple, kiwi, apple, peach, plum, pear, etc.) or a combination of the foregoing flavors. Alternatively, the nutritional supplements may have some other taste or food flavor. Those of ordinary skill in the art may readily determine the taste and smell that various nutritional supplements of the invention may have depending upon the factors described above.

Flavoring and taste-masking agents for edible fats and/or oils, and other ingredients that may be employed in the nutritional supplements of the invention, are commercially available from sources known by those of skill in the art, and include, but are not limited to, high fructose corn syrup, corn syrup, oligofructose, honey, cocoa powder, coffee, sugar (white, brown, powdered, etc.), chocolate, unsweetened chocolate, maltodextrins, natural flavors, for example, citrus, acidic and other natural flavors (grapefruit, grapefruit rind, lemon, lemon rind, lime, lime rind, orange, orange rind, tangerine, cherry, raspberry, blueberry, banana, mango, grape, apple, pear, peach, plum, watermelon, pineapple, coconut, kiwi, etc., or the juice from any of the foregoing) and other components that are known to flavor food products, or to mask the taste of unpleasant tasting food product ingredients. When taste-masking agents are employed in nutritional supplements of the invention, natural flavors and maltodextrins are preferred for use as taste-masking agents.

Artificial sweeteners, such as aspartame, acesulfame, saccharin, cyclamate and sucralose may be employed to flavor and/or sweeten the nutritional supplements of the invention. Saccharin is a sweetener that has no calories and no nutritional value. Preferred is sucralose available commercially as SPLENDA® artificial sweetener from McNeil Nutritionals LLC of Washington, Pa.

In general, the one or more taste agents may be employed in the nutritional formulations of the invention in amounts effective to impart a desired taste to thereto. For example, if present, such taste agents will typically be employed in amounts ranging from about 1.0 to about 30.0 wt. %, based on the total formulation weight, more preferably between about 5.0 to about 20.0 wt. %. When employed in the ready-to-drink liquid nutritional supplement formulations of the invention, the taste agents will most preferably be employed in amounts between about 5.0 wt. % to about 10.0 wt. %, preferably about 8.0 wt. %, based on the total formulation weight.

C. Thickeners

One or more thickeners may be used in the formulations of the present invention in an amount sufficient to impart a desired viscosity and/or texture to the formulation that is suitable for oral or enteral administration.

Preferably, the nutritional supplements include thickners as a part of a “mouthfeel system” that may comprise one or more cellulose gum, cellulose gel, gum arabic, carrageenan and gellan gum, and various combinations thereof.

One preferred mouthfeel system comprises a mixture of gum arabic and carrageenan, for example, a blend of: (a) Avicel® CL-611 (cellulose gum/gel), which is microcrystalline cellulose and carboxymethylcellulose sodium; and (b) VISCARIN® GP209NF (lambda-carrageenan) both of which are commercially available from FMC Corporation of Philadelphia, Pa. Such a mouthfeel system, along with the emulsifier lecithin, provides nutritional supplements of the invention with an emulsification matrix that has a good mouthfeel, which is important for consumer acceptance, and that is safe for consumption by humans.

Gum arabic (acacia gum) can provide stabilization for emulsions, suspensions and general thickening properties, and is naturally derived from plant sources. It can be prepared from an exudate from the stems and branches of sub-Saharan (Sahel zone) Acacia Senegal and Acacia seyal (Leguminosae) trees, and produced naturally as large nodules during gummosis processes. Gum arabic is a complex and variable mixture of arabinogalactan oligosaccharides, polysaccharides and glycoproteins.

Carrageenan is a collective term for polysaccharides prepared by alkaline extraction (and modification) from red seaweed (Rhodophycae), mostly of genus Chondrus, Eucheuma, Gigartina and Iridaea. Different seaweeds produce different carrageenans, such as kappa-carrageenan and iota-carrageenan. Carrageenans are linear polymers of about 25,000 galactose derivatives with regular, but imprecise, structures, dependent on the source and extraction conditions. Carrageenans consist of alternating 3-linked-β-D-galactopyranose and 4-linked-α-D-galactopyranose units.

The thickeners may be employed in the formulations of the present invention in amounts that generally range from between about 0.001 wt. % to about 5.0 wt. %, based on the total formulation weight, preferably from about 0.2 to about 2.0 wt. %, and most preferably between about 0.5 to about 1.0 wt. %. When employed in the ready-to-drink liquid nutritional supplement formulations of the present invention, the thickener will typically be present in amounts from about 0.001 wt. % to about 0.5 wt. %, preferably between about 0.005 wt. % and about 0.1 wt. %, and most preferably between about 0.01 wt. % to about 0.05 wt. %, based on the total formulation weight.

D. Antioxidants

Oxidation is a process that can cause an edible fat or oil to become rancid, and food products including such edible fat or oil to lose their freshness, become less stable and/or have a reduced shelf life. As such, the formulations of the present invention may include one or more antioxidants having an ability to prevent, reduce or aid in the prevention or reduction of, an oxidation, degradation and/or other decomposition (hereinafter “oxidation”) of one or more food product ingredients, such as an edible fat or oil, and/or to prevent, or aid in the prevention of, oxygen-based damage to cells.

Edible antioxidants include, for example, ascorbyl palmitate, various tocopherol mixtures, edible acids (citric acid, ascorbic acid and the like), vitamin A, vitamin C, vitamin E, beta-carotene, selenium, magnesium, herbal extracts, such as a Rosemary, Sage, Oregano, Ginger, Marjoram or Rosemary Oleoresins extract, plant phenols, such as Vanillin, ellagic acid and Resveratrol, and synthetic antioxidants, such as tertiary butylhydroquinone (TBHQ), butylated hydroxyamisole (BHA) or butylated hydroxytoluene (BHT), or mixtures thereof. Antioxidant agents that are particularly beneficial in human nutrition include vitamin A, vitamin C, vitamin E, beta-carotene, ascorbyl palmitate and selenium.

The one or more antioxidants that may be included in the nutritional supplements of the invention generally range from between about 0.01 to about 3.0 wt. % based on total formulation weight, most preferably between about 0.05 to about 0.1 wt. %.

In especially preferred embodiments, the formulations of this invention will include lycopene as an antioxidant in sufficient antioxidation amounts, preferably between about 0.35 to about 2.25 wt. %, more preferably between about 0.40 to about 2.0 wt. %, based on total formulation weight. In this regard, elevated lycopene blood levels have been demonstrated to decrease the levels of oxidized lipoprotein, protein and DNA compounds which, in turn, may lower the risk of cancer and heart disease. Studies have suggested that individuals with high levels of lycopene were half as likely to have a heart attack as compared to individuals with low lycopene levels. The lycopene that may be employed satisfactorily in the practice of the present invention may be obtained from any source including but not limited too tomatoes, watermelons, pink grapefruits, apricots and guavas.

E. Processing Aids

A number of processing aids, including water, may be employed in the formulations of the present invention. Thus, the nutritional supplements of the invention typically include both water-soluble ingredients and fat-soluble ingredients, as well as oils and/or fats and water. In order to combine such ingredients, and to maintain them in a stable formula, nutritional supplements of the invention include one or more edible emulsifiers. Soy lecithin is a preferred emulsifier for inclusion in the nutritional supplements.

During processing, the ingredients may be mixed as a liquid. In order to prevent foaming of the mixture, suitable anti-foaming agents may be employed. On e preferred antifoaming agent is a silicon based antifoam emulsion available commercially as Antifoam™ FG 10 from Basildon Chemical Company Ltd. of Oxon, United Kingdom.

The processing aids may be employed in the formulations of the present invention in amounts sufficient to achieve their desired functional benefits. For example, the processing aids may be employed in amounts between about 0.01 to about 2.5 wt. % based on total formulation weight, and more preferably between about 0.02 to about 1.0 wt. %, and most preferably between about 0.04 to about 0.05 wt. %.

F. Colorants

Any edible food colorant may be included in the formulations of the present invention so as to impart a desired color to the food. For example, solid and/or liquid food colorants may be employed in amounts sufficient to achieve the desired color for the formulation in dependence upon the formulations particular flavor. Thus, a vanilla flavored formulation may include titanium dioxide to impart a “white” or vanilla color to the formulation, while food dyes may be added to impart a “red” or strawberry color to the formulation, a “brown” or chocolate color to the formulation and the like.

The present invention will be further understood from the following non-limiting examples.

### EXAMPLES

### Example 1

### Ready-to-Drink Liquid Vanilla Formulation

A vanilla flavored nutritional drink for glucose intolerant individuals was formulated to include about 18 grams carbohydrates, about 8.5 grams total fat and about 10 grams protein. The formulation comprised the following homogenous blend of ingredients:

| | wt. % of Total |
|---|---|
| Ingredient | Formulation |
| DHA | 0.06 |
| L-arginine | 0.39 |
| Proteins (soy isolate, calcium caseinate and | 4.46 |
| sodium caseinate) | |
| Fats (Lecithin, High Oleic Safflower and canola | 3.32 |
| oil) | |
| Carbohydrates (maltodextrin, cellulose gel, | 7.95 |
| gum arabic, postassium citrate, sodium citrate, | |
| citric acid, inulin) | |
| Vitamins (Vitamins A, C, D, E, B1, B2, B6, K, | 0.55 |
| Biotin, Folic Acid, Niacin, Calcium D, Choline) | |
| Minerals (tricalcium phosphate, potassium | 0.76 |
| chloride, dipotassium phosphate, magnesium | |
| phosphate, chromium, copper sulfate, | |
| potassium iodide, ferrous sulfate, manganese | |
| sulfate, molybedenum sodium molybdate, | |
| selenium, pantothenic acid, zinc sulfate and | |
| inositol) | |
| Other ingredients: thickeners, synthetic | 0.49 |
| sweetener, vanilla flavor agents, colorant, | |
| antifoaming agent | |
| Water | Balance |

A 252 gram serving size of the nutritional vanilla flavored drink was found to have about 190 calories, of which 80 calories were derived from fat (5 calories or which were saturated fat). In addition, the serving size of the nutritional drink had, based on a 2000 calorie diet, 14% of the Recommended Percent Daily Value (PDV) of total fat, 3% RDV of saturated fat, 7% RDV of sodium, 11% RDV of potassium, 6% of total carbohydrate and 12% RDV of dietary fiber. In addition, the following RDV of vitamins, minerals and other nutrients were also present:

| | | |
|---|---|---|
| Vitamin A - 35% | Vitamin C - 100% | Calcium - 25% |
| Iron - 25% | Vitamin D - 30% | Vitamin E - 100% |
| Vitamin K - 25% | Thiamin - 25% | Riboflavin - 25% |
| Niacin - 25% | Vitamin B6 - 50% | Folate - 100% |
| Vitamin B12 - 50% | Biotin - 25% | Pantothenic Acid - 25% |
| Phosphorous - 25% | Iodine - 25% | Magnesium - 25% |
| Zinc - 25% | Selenium - 25% | copper - 25% |
| Manganese - 50% | Chromium - 100% | Molybdenum - 50% |
| Chloride - 10% | | |

### Example 2

### Ready-to-Drink Liquid Chocolate Formulation

Example 1 was repeated except that cocoa and other chocolate flavorings were employed to make a chocolate-flavored formulation. A 252 gram serving size of the nutritional chocolate flavored drink was found to have similar nutritional values as compared to the vanilla flavored drink of Example 1.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A sugar-free nutritional supplement formulation for glucose intolerant patients consisting essentially of:
(a) docosahexaenoic acid (DHA);
(b) L-arginine;
(c) one or more edible fats and/or oils in an amount sufficient to provide between about 25 to about 60% of the total caloric value of the formulation;
(d) non-sugar carbohydrates in an amount sufficient to provide from about 2% to about 30% of the patient's daily energy requirements;
(e) proteins and/or amino acids in an amount sufficient to provide from about 5% to about 50% of the human's daily energy requirements;
(f) an artificial sweetener in an amount to impart a desired sweetness to the formulation; and
(g) a mineral and vitamin package containing minerals and vitamins in amounts sufficient to provide at least 10% of the recommended daily value (RDV) of each mineral and vitamin in the package.

2. The nutritional supplement formulation of claim 1, wherein the DHA is present in an amount between about 0.01 to about 1.25 wt. % based on total formulation weight.

3. The nutritional supplement formulation of claim 1, wherein the L-arginine is present in an amount between about 0.10 to about 5.0 wt. % based on the total formulation weight.

4. The nutritional supplement formulation of claim 1, comprising at least one additional fatty acid other than DHA which is selected from the group consisting of omega-3, omega-6 and omega-9 fatty acids.

5. The nutritional supplement formulation of claim 4, wherein the at least one additional fatty acid is present in an amount less than about 0.10 wt. % based on total formulation weight.

6. The nutritional supplement formulation of claim 1, wherein the edible fats and/or oils comprise a fat blend which includes:
(i) saturated fat in an amount from about 5 to about 14 weight percent based total fat blend weight;
(ii) monounsaturated fat in an amount from about 30 to about 80 weight percent based on total fat blend weight; and
(iii) polyunsaturated in an amount from about 10 to about 40 weight percent based on total fat blend weight.

7. The nutritional supplement formulation of claim 6, wherein the fat blend further includes (iv) diacylglycerol oil in an up to about 80 weight percent based on total fat blend weight.

8. The nutritional supplement formulation of claim 6, wherein the carbohydrates comprise a carbohydrate blend which includes:
(i) maltodextrin in an amount from about 40 to about 95 wt. % based on total carbohydrate blend weight;
(ii) inulin in an amount from about 2.0 to about 15.0 wt. % based on the total carbohydrate blend weight;
(iii) cellulose gel in an amount from about 1.0 to about 15 wt. % based on total carbohydrate blend weight; and
(iv) gum arabic in an amount from about 0.25 to about 6.0 wt. % based on total carbohydrate blend weight.

9. The nutritional supplement formulation of claim 8, wherein the proteins and/or amino acids include at least one protein selected from the group consisting of cereal proteins, milk proteins, egg proteins, whey proteins, bean proteins, soy proteins and peanut proteins.

10. The nutritional supplement formulation of claim 9, which comprises at least one milk protein selected from the group consisting of calcium caseinate, sodium caseinate, sodium calcium caseinate, lactalbumin-casein coprecipitate, and casein.

11. The nutritional supplement formulation of claim 1, further comprising an effective antioxidation amount of lycopene.

12. A ready-to-drink liquid which comprises the sugar-free nutritional supplement formulation of claim 1 homogenously mixed with a potable liquid in an amount sufficient to render the formulation liquid.

13. A solid food bar which comprises the sugar-free nutritional supplement formulation of claim 1.

14. A method of making a nutritional supplement formulation for glucose intolerant patients which comprises homogenously mixing formulation ingredients which consist essentially of:
(a) docosahexaenoic acid (DHA);
(b) L-arginine;
(c) one or more edible fats and/or oils in an amount sufficient to provide between about 25 to about 60% of the total caloric value of the formulation;
(d) non-sugar carbohydrates in an amount sufficient to provide from about 2% to about 30% of the patient's daily energy requirements;
(e) proteins and/or amino acids in an amount sufficient to provide from about 5% to about 50% of the human's daily energy requirements;
(f) an artificial sweetener in an amount to impart a desired sweetness to the formulation; and
(g) a mineral and vitamin package containing minerals and vitamins in amounts sufficient to provide at least 10% of the recommended daily value (RDV) of each mineral and vitamin in the package.

15. The method of claim 14, wherein the DHA is present in an amount between about 0.01 to about 1.25 wt. % based on total formulation weight.

16. The method of claim 14, wherein the L-arginine is present in an amount between about 0.10 to about 5.0 wt. % based on the total formulation weight.

17. The method of claim 14, comprising at least one additional fatty acid other than DHA which is selected from the group consisting of omega-3, omega-6 and omega-9 fatty acids.

18. The method of claim 14, wherein the at least one additional fatty acid is present in an amount less than about 0.10 wt. % based on total formulation weight.

19. The method of claim 14, wherein the edible fats and/or oils comprise a fat blend which includes:
(i) saturated fat in an amount from about 5 to about 14 weight percent based total fat blend weight;
(ii) monounsaturated fat in an amount from about 30 to about 80 weight percent based on total fat blend weight; and
(iii) polyunsaturated in an amount from about 10 to about 40 weight percent based on total fat blend weight.

20. The method of claim 19, wherein the fat blend further includes (iv) diacylglycerol oil in an up to about 80 weight percent based on total fat blend weight.

21. The method of claim 14, wherein the carbohydrates comprise a carbohydrate blend which includes:
(i) maltodextrin in an amount from about 40 to about 95 wt. % based on total carbohydrate blend weight;
(ii) inulin in an amount from about 2.0 to about 15.0 wt. % based on the total carbohydrate blend weight;
(iii) cellulose gel in an amount from about 1.0 to about 15 wt. % based on total carbohydrate blend weight; and
(iv) gum arabic in an amount from about 0.25 to about 6.0 wt. % based on total carbohydrate blend weight.

22. The method of claim 14, wherein the proteins and/or amino acids include at least one protein selected from the group consisting of cereal proteins, milk proteins, egg proteins, whey proteins, bean proteins, soy proteins and peanut proteins.

23. The method of claim 21, which comprises at least one milk protein selected from the group consisting of calcium caseinate, sodium caseinate, sodium calcium caseinate, lactalbumin-casein coprecipitate, and casein.

24. The method of claim 14, wherein the formulation further comprises an effective antioxidation amount of lycopene.

25. A method of providing nutritional supplements to a glucose-intolerant patient comprising administering to a glucose-intolerant patient in need of nutrition supplements a nutritionally supplemental effective amount of a sugar-free nutritional supplement formulation according to any one of claims 1-13.

26. The method of claim 25, wherein said step of administering the formulation is practiced orally or enterally.
